(19) United States
(12) Patent Application Publication
(10) Pub. No.: US 2011/0011565 A1
(43) Pub. Date: Jan. 20, 2011

(54) PLATE-TYPE HEAT PIPE

(75) Inventors: CHUEN-SHU HOU, Tu-Cheng (TW); JIANG-JUN HU, Shenzhen City (CN); FENG-MENG HE, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/560,352

(22) Filed: Sep. 15, 2009

(30) Foreign Application Priority Data
Jul. 17, 2009 (CN) 200910304472.5

(51) Int. Cl. F28D 15/04; G06F 1/20

(52) U.S. Cl. 165/104.26; 165/104.33

(57) ABSTRACT

A plate-type heat pipe includes a container, a wick structure and a plurality of supporting plates. The wick structure is adhered to an inner surface of the container. The supporting plates are received in the container and abut against opposite sidewalls of the container. Each of the supporting plates includes a connecting plate and a plurality of protruded portions extending from the connecting portion. A number of through holes are defined in the protruded portion. The supporting plates are arranged in tiers in a manner such that the protrude portions of a lower supporting plate abut against the connecting portion of an upper supporting plate, and the through holes of the supporting plates communicate with each other.

### BACKGROUND

1. Technical Field

The present disclosure relates to heat pipes and, more particularly, to a plate-type heat pipe having a good heat dissipation efficiency and a steady performance.

2. Description of Related Art

Generally, plate-type heat pipes efficiently dissipate heat from heat-generating components such as a central processing unit (CPU) of a computer. A conventional plate-type heat pipe comprises a container, a continuous wick structure adhered to an inner surface of the container, and a working fluid contained in the container. Because a space between electronic components is narrow, the plate-type heat pipe is thin. When a bottom of the container absorbs heat of the electronic component, a part of the working fluid is vaporized. The vaporized working fluid rushes up to a top portion of the plate-type heat pipe and collides with a condensed working fluid. Thus, the condensed working fluid is blocked by the vapor and a speed of the condensed working fluid flowing back to the bottom of the container decreases. The plate-type heat pipe is prone to be drying.

What is needed, therefore, is a plate-type heat pipe having a good heat dissipation efficiency and a steady performance.

### BRIEF DESCRIPTION OF THE DRAWINGS

FIG. 1 is a cross-section view of a plate-type heat pipe in accordance with the present disclosure.

FIG. 2 is an isometric view of plates of the plate-type heat pipe of FIG. 1.

FIG. 3 is a side view of plates of a plate-type heat pipe of a second embodiment of the present disclosure.

FIG. 4 is an isometric view of the plates of the plate-type heat pipe of FIG. 3.

FIG. 5 is a side view of plates of a plate-type heat pipe of a third embodiment of the present disclosure.

FIG. 6 is an isometric view of the plates of the plate-type heat pipe of FIG. 5.

FIG. 7 is a side view of plates of a plate-type heat pipe of a fourth embodiment of the present disclosure.

FIG. 8 is an isometric view of the plates of the plate-type heat pipe of FIG. 7.

FIG. 9 is a side view of plates of a plate-type heat pipe of a fifth embodiment of the present disclosure.

FIG. 10 is an isometric view of the plates of the plate-type heat pipe of FIG. 9.

FIG. 11 is a side view of plates of a plate-type heat pipe of sixth embodiment of the present disclosure.

FIG. 12 is an isometric view of the plates of the plate-type heat pipe of FIG. 11.

### DETAILED DESCRIPTION

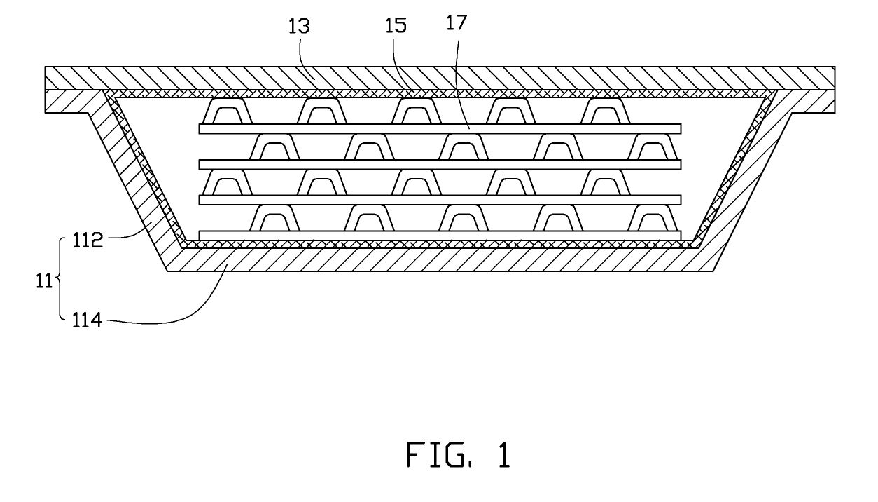

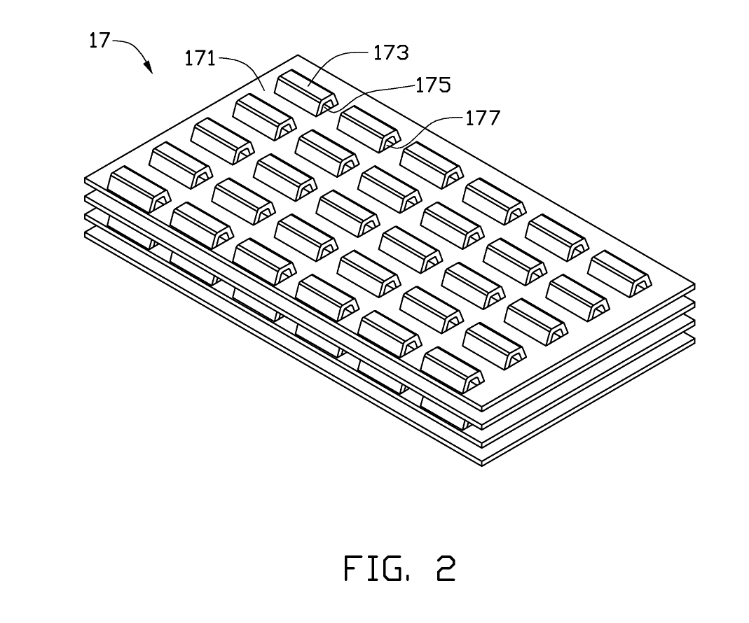

Referring to FIGS. 1-2, they illustrate a plate-type heat pipe in accordance with a first embodiment of the present disclosure. The plate-type heat pipe comprises a bottom cover 11, a top cover 13, a continuous wick structure 15, and a plurality of serried, metallic supporting plates 17. The bottom cover 11 comprises a flat bottom plate 114 and two flat sidewalls 112 extending slantwise and upwardly from opposite ends of the bottom plate 114. The top cover 13 is flat and hermetically contacts with top ends of the sidewalls 112 to define a hermetical chamber (not labeled) to receive working fluid therein. The continuous wick structure 15 is adhered to inner surfaces of the bottom cover 11 and the top cover 13. The supporting plates 17 are sandwiched between the top cover 13 and the bottom plate 114 of the bottom cover 11 and abut against the wick structure 15 located at the inner surface of the top cover 13 and a top surface of the bottom plate 114 of the bottom cover 11.

Each of the supporting plates 17 comprises a rectangular connecting portion 171 and a number of protruded portions 173 extending upwardly from a top surface of the connecting portion 171. The protruded portions 173 are spaced from and align with each other along a length direction and a width direction of the connecting portion 171. Each of the protruded portions 173 has a trapeziform configuration. A through groove 175 is defined in a central portion of the protruded portion 173 along the length direction of the connecting portion 171. A rectangular through hole 177 is defined vertically through the connecting portion 171 under a corresponding protruded portion 173. Each of the through holes 177 communicates with the through groove 175 of the corresponding protruded portion 173. The protruded portions 173 and the connecting portion 171 define a plurality of channels (not labeled). The vaporized working fluid flows through the channels.

The supporting plates 17 are arranged in tiers in a manner such that a row of protruded portions 173 of a lower supporting plate 17 abut against the connecting portion 171 between the adjacent rows of protruded portions 173 of an upper supporting plate 17 along a length direction of the connecting portion 171. The connecting portions 171 define a plurality of passages therebetween, and adjacent passages fluidly communicate with each other by the through holes 177 defined in the connecting portions 171. In addition, the protruded portions 173 and the connecting portion 171 of a supporting plate 17 form a plurality of channels therebetween. The channels of the adjoining supporting plates 17 are alternated along a width direction of the adjoining supporting plates 17. The passages and the channels are configured to increase a length of a path of the vaporized working fluid. Therefore, a speed of the vaporized working fluid of the plate-type is decreased relative to the conventional plate-type heat pipe to avoid a powerful impact of the vaporized working fluid on the condensed working fluid. Heat of the vaporized working fluid is evenly absorbed by the supporting plates 17 to make the condensed working fluid flows back quickly.

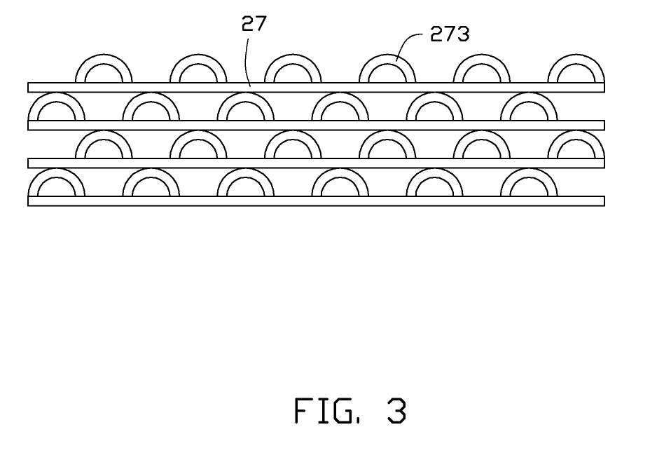

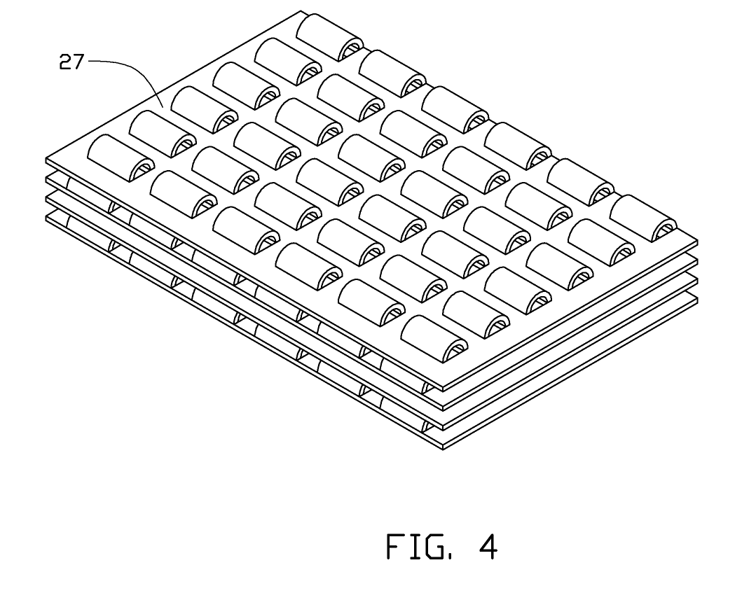

Referring to FIGS. 3-4, they illustrate a number of supporting plates 27 of a plate-type heat pipe in accordance with a second embodiment of the present disclosure. A configuration of the supporting plates 27 is similar to the supporting plates 17 of the first embodiment. A difference between the supporting plates 27, 17 is that a protruded portion 273 of the supporting plate 27 has an arc-shaped configuration.

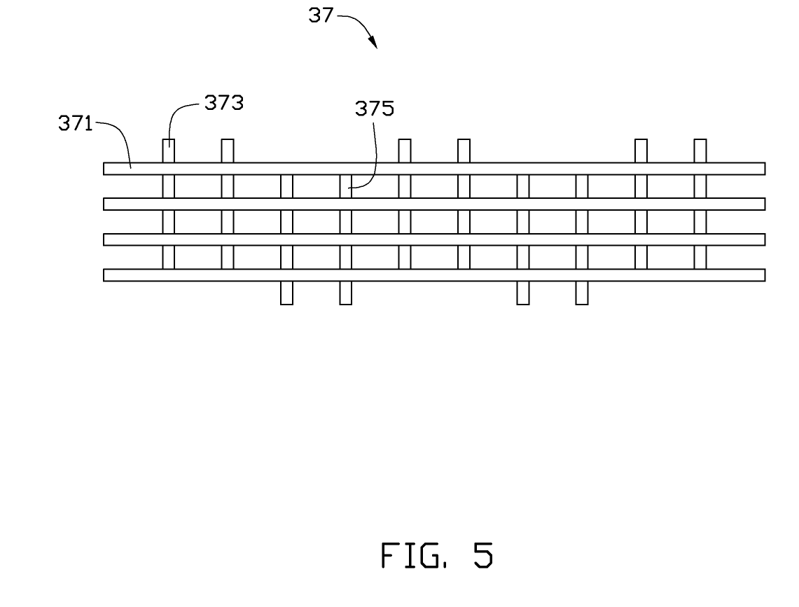

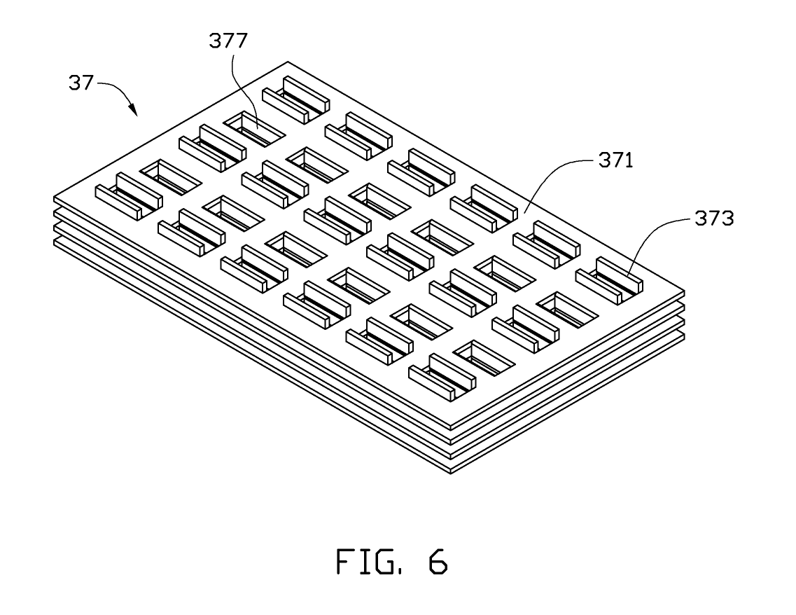

Referring to FIGS. 5-6, they illustrate a number of supporting plates 37 of a plate-type heat pipe in accordance with a third embodiment of the present disclosure. Each of the supporting plates 37 comprises a rectangular connecting portion 371 and a number of pairs of first protruded portions 373 perpendicularly extending upwardly from a top surface of the supporting plates 37, and a number of pairs of second protruded portions 375 extending downwardly from a bottom surface of the supporting plate 37. Each of the first and second protruded portions 373, 375 is a rectangular plate. The pairs of first protruded portions 373 are spaced from each other. The connecting portion 371 defines a plurality of through holes 377 between adjacent pairs of first protruded portions 373. Each pair of second protruded portions 375 protrudes downwardly from two opposite edges defining one of the through holes 377. For example, the first protruded portions 373 are located at a top side of the connecting portion 371 and arranged in three neat rows along a length direction of the connecting portion 371. The second protruded portions 375 are located at a bottom side of the connecting portion 371 and arranged in two neat rows along the length direction of the connecting portion 371. The rows of the first and second protruded portions 373, 375 are alternate. The supporting plates 37 are arranged in tiers. Top ends of the first protruded portions 373 of a lower supporting plate 37 abut against a bottom surface of an upper supporting plate 37 just under the first protruded portions 373 of the upper supporting plate 37. Bottom ends of the second protruded portions 375 of the upper supporting plate 37 abut against a top surface of the lower supporting plate 37 just over the second protruded portions 375 of the lower supporting plate 37. Thus, the through holes 377 of the supporting plates 37 align with each other to define a number of straight channels. The vaporized working fluid flows through the straight channels from bottom to top.

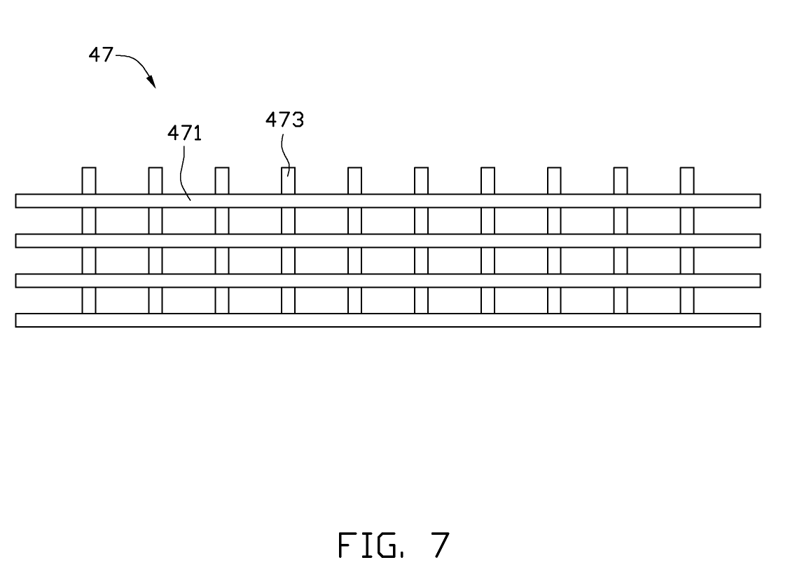

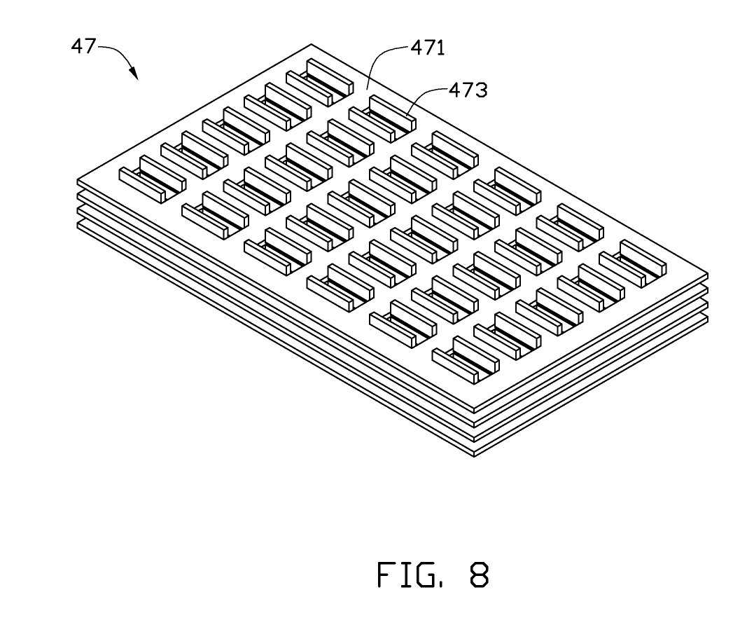

Referring to FIGS. 7-8, they illustrate a number of supporting plates 47 of a plate-type heat pipe in accordance with a fourth embodiment of the present disclosure. A configuration of the supporting plates 47 is similar to the supporting plates 37 of the third embodiment. A difference between the supporting plates 47, 37 is that a number of protruded portions 473 perpendicularly extend upwardly from a top surface of a connecting portion 471 of the supporting plate 47. The protruded portions 473 are all oriented toward the same direction.

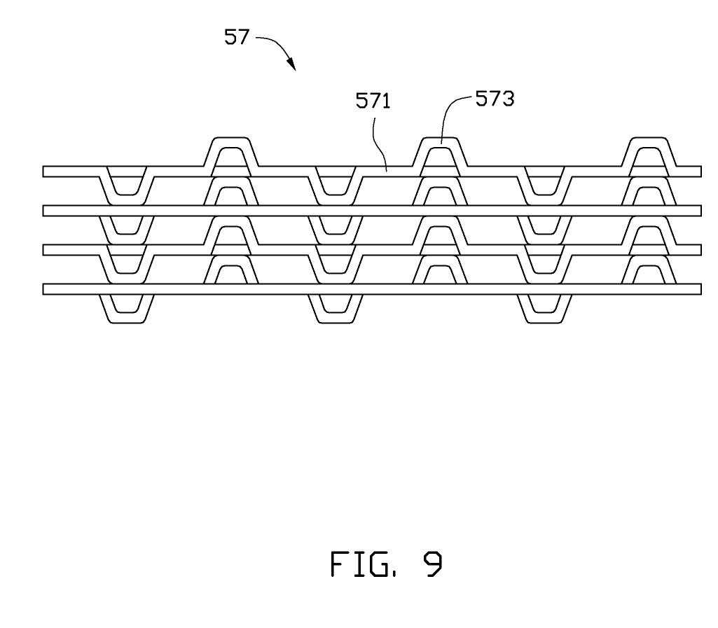

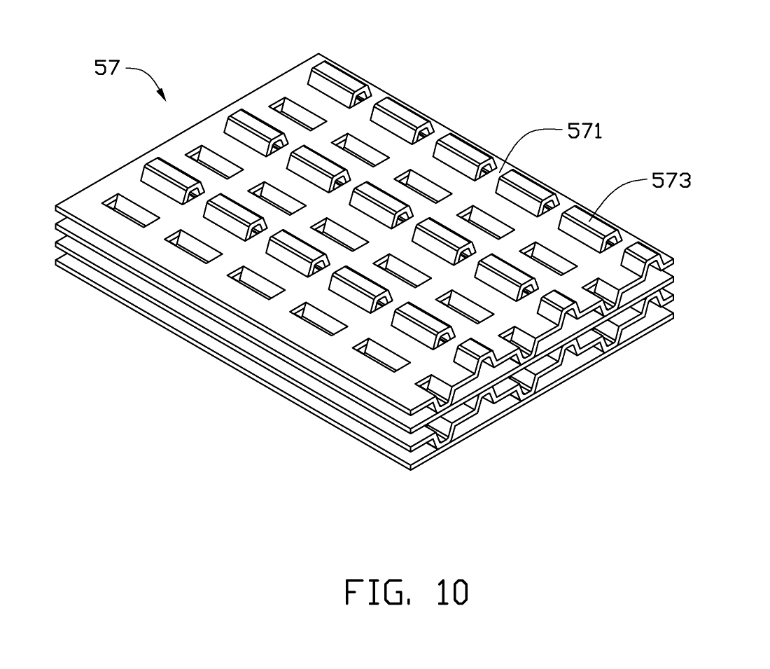

Referring to FIGS. 9-10, they illustrate a number of supporting plates 57 of a plate-type heat pipe in accordance with a fifth embodiment of the present disclosure. A configuration of the supporting plates 57 is the same to the supporting plates 17 of the first embodiment. The supporting plate 57 comprises an elongated connecting portion 571 and a number of protruded portions 573 extending from the connecting portion 571. The protruded portions 573 are arranged in a number of rows along a length direction of the connecting portion 571. A difference between the supporting plates 57, 17 is that the adjoining rows of the protruded portions 573 of the supporting plate 57 are oriented toward opposite directions. Top ends of the protruded portions 573 of a lower supporting plate 57 abut against the connecting portion 571 located between corresponding protruded portions 573 of an adjacent upper supporting plate 57.

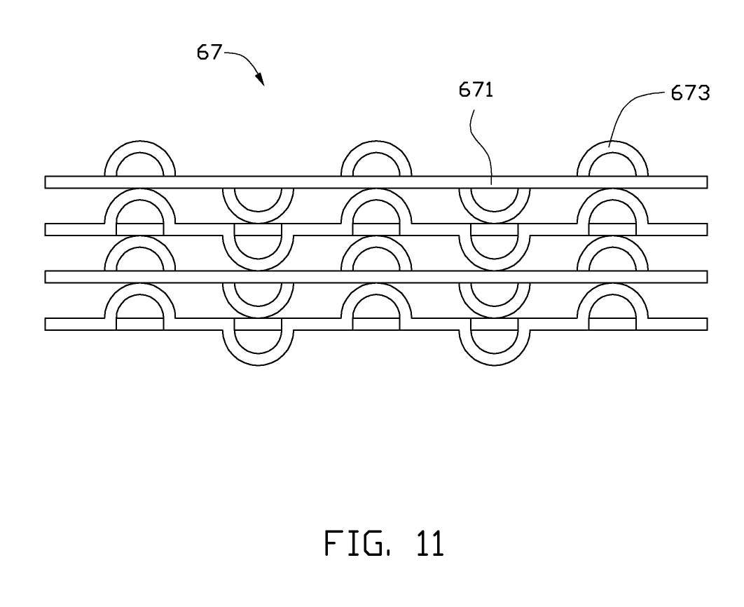

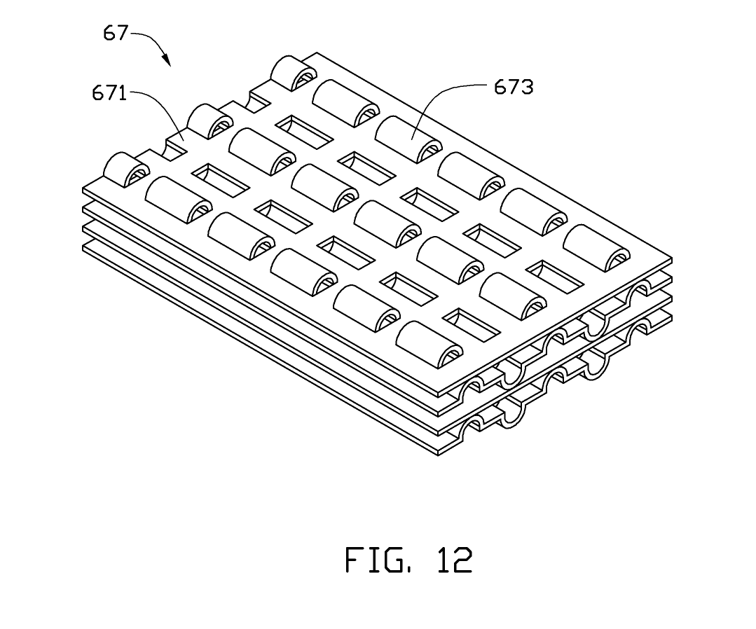

Referring to FIGS. 11-12, they illustrate a number of supporting plates 67 of a plate-type heat pipe in accordance with a sixth embodiment of the present disclosure. A configuration of the supporting plates 67 is similar to the supporting plates 57 of the fifth embodiment. Each of the supporting plates 67 comprises a rectangular connecting plate 671 and a number of protruded portions 673 extending from the connecting portion 671 and oriented toward opposite directions. A difference between the supporting plates 67, 57 is that the protruded portion 673 has an arc-shaped configuration.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A plate-type heat pipe comprising:
a container;
a wick structure adhered to an inner surface of the container; and
a plurality of supporting plates received in the container and abutting against opposite sidewalls of the container, each of the supporting plates comprising a connecting plate and a plurality of protruded portions extending from the connecting portion, the connecting plate of each of the supporting plates defining a plurality of through holes;
wherein the supporting plates are arranged in tiers in a manner such that the protrude portions of a lower supporting plate abut against the connecting portion of an upper supporting plate, and the through holes of the supporting plates communicate with each other.

2. The plate-type heat pipe as claimed in claim 1, wherein the protruded portions are spaced from and align with each other along a length direction and a width direction of the connecting portion.

3. The plate-type heat pipe as claimed in claim 2, wherein each of the through holes is defined under a corresponding protruded portion.

4. The plate-type heat pipe as claimed in claim 3, wherein each of the protruded portions defines a through groove communicating with a corresponding one of the through holes.

5. The plate-type heat pipe as claimed in claim 4, wherein the groove is defined in each of the protruded portions along a lengthwise direction of the connecting portion.

6. The plate-type heat pipe as claimed in claim 4, wherein two adjoining supporting plates are arranged in tiers in a manner such that a row of protruded portions of a lower supporting plate abut against the connecting portion between two adjacent rows of protruded portions of an upper supporting plate along a length direction of the connecting portion.

7. The plate-type heat pipe as claimed in claim 1, wherein the protruded portions extend upwardly from a top surface of the connecting portion and are oriented toward the same direction.

8. The plate-type heat pipe as claimed in claim 4, wherein the protruded portions extend upwardly from a top surface of the connecting portion and downwardly from a bottom surface of the connecting portion of the supporting plate, respectively.

9. The plate-type heat pipe as claimed in claim 8, wherein the protruded portions are arranged in a plurality of rows, and adjoining rows of the protruded portions are oriented toward opposite directions.

10. The plate-type heat pipe as claimed in claim 9, wherein two adjoining supporting plates are arranged in tiers in a manner such that top ends of the protruded portions of a lower supporting plate abut against the connecting portion located between corresponding protruded portions of an upper supporting plate.

11. The plate-type heat pipe as claimed in claim 10, wherein the protruded portions of corresponding rows of the two adjoining supporting plates are alternated.

12. The plate-type heat pipe as claimed in claim 1, wherein each of the protruded portions has one of an arc-shaped configuration and trapeziform configuration.

13. The plate-type heat pipe as claimed in claim 1, wherein each of the protruded portions is an elongated plate and the through holes each is defined between a pair of the plates.

14. The plate-type heat pipe as claimed in claim 13, wherein top ends of the protruded portions of a lower supporting plate abut against bottom ends of the protruded portions of an upper supporting plate to make the through holes align with each other.

15. The plate-type heat pipe as claimed in claim 14, wherein the plates are oriented toward the same direction.

16. The plate-type heat pipe as claimed in claim 14, wherein the plates are arranged in a number of rows and adjoining rows are oriented toward opposite directions.
